(19) United States
(12) Patent Application Publication
(10) Pub. No.: US 2026/0244986 A1
(43) Pub. Date: Aug. 20, 2026

(54) LEARNING DEVICE, LEARNING METHOD, AND RECORDING MEDIUM

(71) Applicant: NEC Corporation, Tokyo (JP)

(72) Inventors: Ryoma OUCHI, Tokyo (JP); Makoto TERAO, Tokyo (JP)

(73) Assignee: NEC Corporation, Tokyo (JP)

(21) Appl. No.: 19/161,775

(22) PCT Filed: Mar. 15, 2023
(86) PCT No.: PCT/JP2023/010094

§ 371 Date: Sep. 3, 2025

(51) Int. Cl. G06N 20/00

(52) U.S. Cl. CPC G06N 20/00

(57) ABSTRACT

A learning device includes a class association unit that associates, with a data set for training, a class indicated by a label assigned to data included in the data set for training; a class propagation unit that associates, with the data set for training, a class associated with another data set for training on the basis of the similarity between data sets for training; a pseudo label assigning unit that assigns a pseudo label to data to which the labels included in the data sets for training are not assigned; and a learning unit that executes machine learning by using the data set for training including the data to which the pseudo label is assigned. The pseudo label assigning unit limits pseudo labels to be assigned to data included in a data set for training on the basis of the class associated with the data set for training.

### TECHNICAL FIELD

The present invention relates to a learning device, a learning method, and a learning program.

### BACKGROUND ART

In machine learning, it is required to reduce teacher data collection cost. For example, when machine learning of the time-series data section recognition task is performed, it is a problem to reduce a high labeling cost.

The time-series data section recognition task is a task of classifying data xi in each time to a class yi (yi□Y={y1, y2, . . . , yK}) when certain time-series data X (X=[x1, x2, . . . , xT]) is given. Here, the class yi may be one class or a plurality of classes.

In order to learn the time-series data section recognition task, the correct class label yi is generally given as teacher data to all the time-series data xi. The class label in this case is referred to as a Full label. The labeling cost of the Full label is very large.

Therefore, in order to reduce the labeling cost in the time-series data section recognition task, it has been studied to label only some labels.

That is, the class yi (yi□Y={y1, y2, . . . , yK}) is given as the teacher data only for the elements xi of the subset X\hat{ }□X of X among the time-series data X (X=[x1, x2, . . . , xT]). Such a class label is referred to as a weak label. Generally, the labeling cost of the weak label is lower than that of the Full label.

For example, NPL 1 describes a method of learning a moving image action section recognition task, which is an example of a time-series data section recognition task, using a weak label. In the above method, first, a model is learned using a Timestamp type label. Next, using the inference result of the learned model, a pseudo label is assigned to a neighboring region of the data at the time when the label is assigned, and is used for learning together. The pseudo label is a label given in a pseudo manner to data at a time at which no label is given.

### CITATION LIST

### Non Patent Literature

NPL 1: Ma et al., SF-Net: Single-Frame Supervision for Temporal Action Localization, ECCV 2020

### SUMMARY OF INVENTION

### Technical Problem

However, in the related art of NPL 1, since a pseudo label is assigned only to the vicinity of data at a time at which a label is assigned in time-series data, a pseudo label cannot be assigned to a time region away from the time at which the label is assigned or time-series data to which a label is not assigned in the first place, and there is a limit to improvement in inference accuracy.

An aspect of the present invention has been made in view of the above problems, and an example of an object thereof is to enable learning of a high-accurate model while reducing labeling cost for a machine learning model that infers which class data at each time of time-series data set is classified into.

### Solution to Problem

A learning device according to one aspect of the present invention is a learning device that performs machine learning of a machine learning model that infers into which class data at each time of a time-series data set is classified by using a plurality of time-series data sets for training, the learning device including a class association unit that associates a class indicated by a label attached to data included in each time-series data set for training with each time-series data set for training, the label indicating the class being given to some pieces of data included in the plurality of time-series data sets for training, a class propagation unit that associates at least a part of a class associated with other time-series data sets for training with at least one time-series data set for training based on a similarity between the time-series data sets for training, a pseudo label assigning unit that assigns, to each time-series data set for training, a pseudo label indicating a class into which the machine learning model has classified the data to data to which the label in the time-series data set for training is not assigned, and a learning unit that performs machine learning of the machine learning model by using the plurality of time-series data sets for training including the data to which the pseudo label is given, in which the pseudo label assigning unit limits the pseudo label assigned to data included in the time-series data set for training based on a class associated with each time-series data set for training.

A learning method according to one aspect of the present invention is a learning method for performing machine learning of a machine learning model that infers into which class data at each time of a time-series data set is classified by using a plurality of time-series data sets for training, the learning method including a class association process of associating a class indicated by a label attached to data included in each time-series data set for training with each time-series data set for training, the label indicating the class being given to some pieces of data included in the plurality of time-series data sets for training; a class propagation process of associating at least a part of a class associated with other time-series data sets for training with at least one time-series data set for training based on a similarity between the time-series data sets for training, a pseudo label assigning process of assigning, to each time-series data set for training, a pseudo label indicating a class into which the machine learning model has classified the data to data to which the label in the time-series data set for training is not assigned, and a learning process of performing machine learning of the machine learning model by using the plurality of time-series data sets for training including the data to which the pseudo label is given, in which the pseudo label assigning process limits the pseudo label assigned to data included in the time-series data set for training based on a class associated with each time-series data set for training.

A learning program according to one aspect of the present invention is a learning program for causing a computer to execute machine learning of a machine learning model that infers into which class data at each time of a time-series data set is classified by using a plurality of time-series data sets for training, the program causing the computer to execute a class association process of associating a class indicated by a label attached to data included in each time-series data set for training with each time-series data set for training, the label indicating the class being given to some pieces of data included in the plurality of time-series data sets for training, a class propagation process of associating at least a part of a class associated with other time-series data sets for training with at least one time-series data set for training based on a similarity between the time-series data sets for training, a pseudo label assigning process of assigning, to each time-series data set for training, a pseudo label indicating a class into which the machine learning model has classified the data to data to which the label in the time-series data set for training is not assigned, and a learning process of performing machine learning of the machine learning model by using the plurality of time-series data sets for training including the data to which the pseudo label is given, in which the pseudo label assigning process limits the pseudo label assigned to data included in the time-series data set for training based on a class associated with each time-series data set for training.

### Advantageous Effects of Invention

An object is to enable learning of a high-accurate model while reducing labeling cost for a machine learning model that infers which class data at each time of time-series data set is classified into.

### BRIEF DESCRIPTION OF DRAWINGS

FIG. 1 is a block diagram illustrating a configuration of a learning device according to a first example embodiment of the present invention.

FIG. 2 is a flowchart illustrating a flow of a learning method according to the first example embodiment of the present invention.

FIG. 3 is a block diagram illustrating a configuration of a learning device according to a second example embodiment of the present invention.

FIG. 4 is a flowchart illustrating a flow of a learning method according to the second example embodiment of the present invention.

FIG. 5 is a block diagram illustrating a configuration of a learning device according to a third example embodiment of the present invention.

FIG. 6 is a flowchart illustrating a flow of a learning method according to the third example embodiment of the present invention.

FIG. 7 is a block diagram illustrating a hardware configuration example of each device according to each exemplary example embodiment of the present invention.

### EXAMPLE EMBODIMENT

### First Example Embodiment

A first example embodiment of the present invention will be described in detail with reference to the drawings. The present example embodiment is a basic form of the example embodiment to be described later.

### Configuration of Learning Device 1

A learning device 1 according to the present example embodiment performs machine learning of a machine learning model that infers which class the data at each time of the time-series data set is classified into using a plurality of time-series data sets for training. A label indicating a class is given to some pieces of data included in the plurality of time-series data sets for training. The label indicating the class may be, for example, one label given to one piece of data at each time of the time-series data set, or may be a multi-label given a plurality of times. The plurality of time-series data sets for training may include, for example, a plurality of pieces of independent data, or may include a plurality of time-series data sets having a relationship with each other, the plurality of time-series data sets being generated by dividing one time-series data set into a plurality of pieces. These time-series data sets are any of time-series data with a Full label, time-series data with some labels, or time-series data with no labels at all. The time-series data may be, for example, a moving image or audio. Examples of the time-series data section recognition task that is a target of machine learning include a task of inferring a class representing each action in a moving image and a section thereof in detecting an action section in the moving image. Another example of the time-series data section recognition task includes a task of classifying a voice at each time with respect to time-series data of a voice in event section detection in the audio. The data at each time of the time-series data set is relevant to, for example, a frame in a moving image or audio.

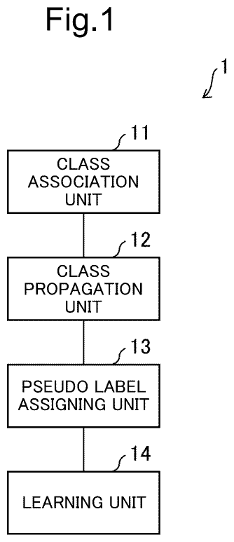

A configuration of the learning device 1 according to the present example embodiment will be described with reference to FIG. 1. FIG. 1 is a block diagram illustrating the configuration of the learning device 1. As illustrated in FIG. 1, the learning device 1 includes a class association unit 11, a class propagation unit 12, a pseudo label assigning unit 13, and a learning unit 14.

The class association unit 11 associates a class indicated by a label assigned to data included in the time-series data set for training with each time-series data set for training. The class association means that a class is associated with the entire time-series data. The class association unit 11 assigns the class indicated by the label assigned to the data included in the time-series data to the time-series data. For example, in a case where the time-series data is a moving image, it indicates that a class indicated by a label assigned to a frame in the moving image is assigned to each moving image. In one aspect, in a case where a class relevant to the time-series data is directly designated, the class association unit 11 may assign the class to the time-series data.

The class propagation unit 12 associates at least a part of the class associated with another time-series data set for training with at least one time-series data set for training based on the similarity between the time-series data sets for training. The similarity indicates how similar the features of the time-series data sets are to each other.

In one aspect, a feature of units of time-series data set is represented by a feature amount. In a case where the time-series data set is a moving image, the feature amount in the moving image is, for example, an average of the feature amounts of all frames. In the space representing the feature amount, it is determined that the similarity is higher as the position where the feature amount exists is closer. In the class propagation unit 12, it is assumed that time-series data set having sufficiently high similarity have similar classes, and all or some of the classes associated with the time-series data set are associated with the other time-series data set.

For example, the class propagation unit 12 may select K time-series data sets (K is a natural number and equal to or less than the total number of time-series data sets) in ascending order of similarity to the time-series data set of which the class in the time-series data set is known, and assign all or some of the classes in the time-series data set.

For example, when the class propagation unit 12 focuses on certain time-series data set of which the class in the time-series data set is unknown, only in a case where a label of the same class is given from a plurality of pieces of labeled time-series data set, the label of the class may be regarded as reliable and set as a valid class.

For example, in a case where the class propagation unit 12 focuses on certain time-series data set whose class in the time-series data set is unknown, when there is a plurality of time-series data set whose class in the time-series data set is known and similarity is close, a known class in the time-series data set having the largest total number may be assigned to the time-series data set whose class in the time-series data set is unknown.

For example, in the class propagation unit 12, the class within the time-series data set may be assigned by weighting, with the similarity, the time-series data set having sufficiently close similarity.

For example, in the class propagation unit 12, the propagated class in the time-series data set may be further assigned to another time-series data set.

For each time-series data set for training, the pseudo label assigning unit 13 assigns a pseudo label indicating a class into which the machine learning model has classified the data, to the data having no assigned label in the time-series data set for training. In the time-series data set, a pseudo label based on data to which a label has already been assigned can be assigned to both data having no assigned label and data having an assigned label.

The pseudo label assigning unit 13 limits the pseudo label to be assigned to the data included in the time-series data set for training based on the class associated with each time-series data set for training. In the pseudo label assigning unit 13, the pseudo label to be assigned is limited based on the class already associated with the time-series data set. Examples of the limit condition include a constraint condition in the second example embodiment described later.

By limiting the pseudo label given to the data included in each time-series data set based on the class already associated with the time-series data set or the time-series data set similar to the time-series data set, it is possible to suppress giving of a pseudo label of a wrong class such as a class not present in the time-series data set.

The learning unit 14 performs machine learning on the machine learning model by using a plurality of time-series data sets for training including data to which pseudo labels are given.

### Flow of Learning Method S1

The learning device 1 configured as described above executes a learning method S1 according to the present example embodiment.

In the learning method S1, machine learning is performed on a machine learning model that infers which class the data at each time of the time-series data set is classified into using a plurality of time-series data sets for training. A label indicating a class is given to some pieces of data included in the plurality of time-series data sets for training.

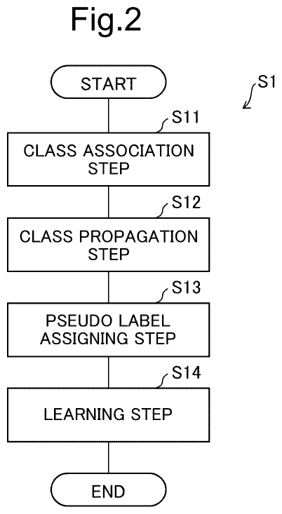

A flow of the learning method S1 will be described with reference to FIG. 2. FIG. 2 is a flowchart illustrating the flow of the learning method S1. As illustrated in FIG. 2, the learning method S1 includes a class association step S11, a class propagation step S12, a pseudo label assigning step S13, and a learning step S14. In the class association step S11, the class association unit 11 associates a class indicated by a label assigned to data included in the time-series data set for training with each time-series data set for training. In the class propagation step S12, the class propagation unit 12 associates at least a part of the class associated with another time-series data set for training with at least one time-series data set for training based on the similarity between the time-series data sets for training. In the pseudo label assigning step S13, for each time-series data set for training, the pseudo label assigning unit 13 assigns a pseudo label indicating a class into which the machine learning model has classified the data, to the data having no assigned label in the time-series data set for training. The pseudo label assigning step S13 limits the pseudo label to be assigned to the data included in the time-series data set for training based on the class associated with each time-series data set for training. In learning step S14, the learning unit 14 performs machine learning on the machine learning model by using a plurality of time-series data sets for training including data to which pseudo labels are given.

### Effects of Present Example Embodiment

As described above, according to the learning device 1 and the learning method S1 according to the present example embodiment, it is possible to suppress assignment of a pseudo label of a wrong class such as a class not present in the time-series data set for training. As a result, the number and variations of assigned pseudo labels increase, and it is expected that high inference accuracy can be obtained.

### Second Example Embodiment

A second example embodiment of the present invention will be described in detail with reference to the drawings. Components having the same functions as the components described in the first example embodiment are denoted by the same reference signs, and the description thereof will be appropriately omitted.

### Configuration of Learning Device 10

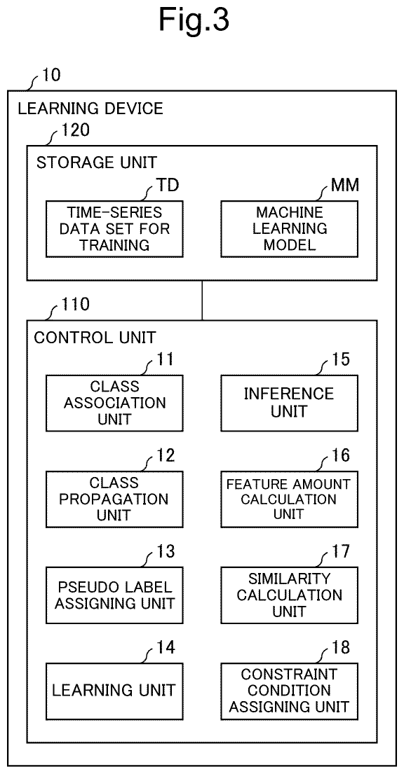

A configuration of the learning device 10 according to the second example embodiment of the present invention will be described with reference to FIG. 3. FIG. 3 is a block diagram illustrating a functional configuration of the learning device 10. As illustrated in FIG. 3, the learning device 10 includes a control unit 110 and a storage unit 120. The control unit 110 integrally controls each unit of the learning device 10. The control unit 110 includes a class association unit 11, a class propagation unit 12, a pseudo label assigning unit 13, a learning unit 14, an inference unit 15, a feature amount calculation unit 16, a similarity calculation unit 17, and a constraint condition assigning unit 18. The storage unit 120 stores various pieces of data used by the control unit 110. For example, the storage unit 120 stores a time-series data set for training TD and a machine learning model MM.

The class association unit 11 associates a class indicated by a label assigned to data included in the time-series data set for training TD with each time-series data set for training TD. The class association means that a class is associated with the entire time-series data. The class association unit 11 assigns the class indicated by the label assigned to the data included in the time-series data to the time-series data. For example, in a case where the time-series data is a moving image, it indicates that a class indicated by a label assigned to a frame in the moving image is assigned to each moving image. In one aspect, in a case where a class relevant to the time-series data is directly designated, the class association unit 11 may assign the class to the time-series data.

The class propagation unit 12 associates at least a part of the class associated with another time-series data set for training TD with at least one time-series data set for training TD based on the similarity between the time-series data sets for training TD. The similarity indicates how similar the features of the time-series data sets are to each other.

In one aspect, a feature of units of time-series data set is represented by a feature amount. In a case where the time-series data set is a moving image, the feature amount in the moving image is, for example, an average of the feature amounts of all frames. In the space representing the feature amount, it is determined that the similarity is higher as the position where the feature amount exists is closer. In the class propagation unit 12, it is assumed that time-series data set having sufficiently high similarity have similar classes, and all or some of the classes associated with the time-series data set are associated with the other time-series data set.

For example, the class propagation unit 12 may associate all the classes associated with the first time-series data set with the second time-series data set having a similarity equal to or more than a predetermined threshold with the first time-series data set. The class propagation unit 12 may associate some classes associated with the first time-series data set with the second time-series data set having a similarity equal to or more than a predetermined threshold with the first time-series data set. For example, for the time-series data sets, a feature amount may be generated for each class, and the class may be propagated between time-series data sets in which the similarity of the feature amounts related to the class is equal to or more than a predetermined threshold. That is, when there is the time-series data set having the classes A, B, and C, the class A may be assigned in a case where the similarity of the feature amounts of the class A is sufficiently high, and the class C may not be assigned in a case where the similarity of the feature amounts of the class C is sufficiently low. Thus, only a part of the classes may be assigned to the time-series data set having the plurality of classes. The feature amount for each class may be calculated, for example, by using a machine learning model obtained by machine learning such that each piece of data of the time-series data set is input and the feature amount is output such that the output feature amount increases when the data to which each class is assigned is input.

For example, the class propagation unit 12 may select K time-series data sets (K is a natural number and equal to or less than the total number of time-series data sets) in ascending order of similarity to the time-series data set of which the class in the time-series data set is known, and assign all or some of the classes in the time-series data set.

For example, when the class propagation unit 12 focuses on certain time-series data set of which the class in the time-series data set is unknown, only in a case where a label of the same class is given from a plurality of pieces of labeled time-series data set, the label of the class may be regarded as reliable and set as a valid class.

For example, in a case where the class propagation unit 12 focuses on certain time-series data set whose class in the time-series data set is unknown, when there is a plurality of time-series data set whose class in the time-series data set is known and similarity is close, a known class in the time-series data set having the largest total number may be assigned to the time-series data set whose class in the time-series data set is unknown.

For example, in the class propagation unit 12, the class within the time-series data set may be assigned by weighting, with the similarity, the time-series data set having sufficiently close similarity.

For example, in the class propagation unit 12, the propagated class in the time-series data set may be further assigned to another time-series data set.

For each time-series data set for training TD, the pseudo label assigning unit 13 assigns a pseudo label indicating a class into which the machine learning model MM has classified the data, to the data having no assigned label in the time-series data set for training TD. In the time-series data set, a pseudo label based on data to which a label has already been assigned can be assigned to both data having no assigned label and data having an assigned label.

The pseudo label assigning unit 13 limits the pseudo label to be assigned to the data included in the time-series data set for training TD based on the class associated with each time-series data set for training TD. In the pseudo label assigning unit 13, the pseudo label to be assigned is limited based on the class already associated with the time-series data set. Examples of the limit condition include a constraint condition in the second example embodiment described later.

By limiting the pseudo label given to the data included in each time-series data set based on the class already associated with the time-series data set or the time-series data set similar to the time-series data set, it is possible to suppress giving of a pseudo label of a wrong class such as a class not present in the time-series data set.

The learning unit 14 performs machine learning on the machine learning model MM by using a plurality of time-series data sets for training TD including data to which pseudo labels are given. For example, the learning unit 14 may further include a configuration that calculates a loss using a label originally assigned in the time-series data set for training TD, a pseudo label assigned in the time-series data set for training TD, and a result of inference as inputs, and updates a parameter of the machine learning model MM using the loss as an input. The loss indicates a magnitude of a deviation between a label originally assigned in the time-series data set for training TD or a pseudo label assigned to the time-series data set for training TD and a result of inference.

The inference unit 15 infers which class the data at each time of the time-series data set for training TD is classified into.

The feature amount calculation unit 16 calculates a feature amount in units of time-series data sets for each time-series data set for training TD. For example, the feature amount may be an output result of a pre-learned model, a color feature, or meta information. The meta information may be, for example, an acquisition time of the time-series data set or an acquisition place of the time-series data set. For example, in a case where the time-series data set is a moving image, the angle of view of the moving image acquisition camera may be used as the feature amount.

For example, when the time-series data set is passed through the neural network, the feature amount calculation unit 16 may calculate the feature amount from a value representing a feature of each piece of data at each time of the time-series data set output from the intermediate layer and the last layer of the neural network. The feature amount may be calculated after pooling processing such as averaging is performed on the output value. When performing pooling, pooling may be performed by weighting with a prediction score or the like. The output value may be further passed through another neural network, and distance learning (metric learning) or contrastive learning may be performed on the space, for example.

For example, the feature amount calculation unit 16 may calculate the feature amount from a time ratio (for example, in a case where the time-series data section is the action section in the moving image, which action has what time ratio) of the time-series data section estimated from the inference result. In this case, for example, the feature amount may be calculated so that it can be determined that the similarity between the moving images is high when the action time ratios in the moving images are similar.

The similarity calculation unit 17 calculates the similarity between the time-series data sets for training TD using the feature amount. For example, cosine similarity, Euclidean distance, Manhattan distance (L1 norm), and Kullback-Leibler divergence (K-L divergence) may be used for similarity calculation.

The constraint condition assigning unit 18 assigns a constraint condition to limit the class of the pseudo label to the class of the label originally present in the time-series data set for training TD or the class of the label in the time-series data set for training TD obtained by being assigned by the class propagation unit.

For example, the constraint condition assigning unit 18 may set a constraint condition that limits the application of the pseudo label to only the class in the time-series data set for training TD and does not apply the pseudo label to other classes.

For example, when the pseudo label assigning unit 13 assigns the pseudo label to data whose inference score exceeds the pseudo label threshold among the time-series data sets for training TD satisfying the constraint condition, the constraint condition assigning unit 18 may assign different pseudo label thresholds to the same class as the class of the label in the time-series data set for training TD and to other classes.

For example, the constraint condition assigning unit 18 may change the constraint condition on the time-series data set for training TD according to the progress status of the machine learning. Examples of the change include elimination or loosening of the constraint condition.

### Flow of Learning Method S10

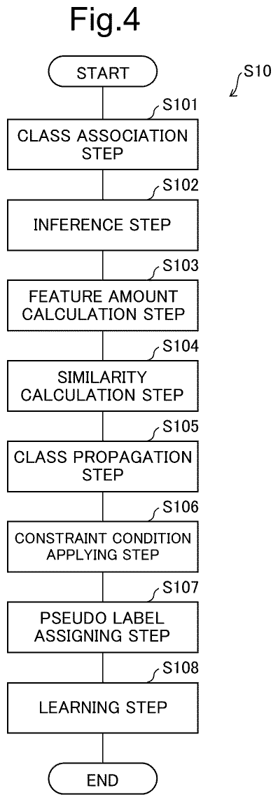

The learning device 10 configured as described above executes a learning method S10 according to the present example embodiment. A flow of the learning method S10 will be described with reference to FIG. 4. FIG. 4 is a flowchart illustrating the flow of the learning method S10. As illustrated in FIG. 4, the learning method S10 includes steps S101 to S108.

In the class association step S101, the class association unit 11 associates a class indicated by a label assigned to data included in the time-series data set for training TD with each time-series data set for training TD.

In the inference step S102, the inference unit 15 infers which class the data at each time of the time-series data set for training TD is classified into.

In the feature amount calculation step S103, the feature amount calculation unit 16 calculates a feature amount in units of time-series data sets for each time-series data set for training TD.

In the similarity calculation step S104, the similarity calculation unit 17 calculates the similarity between the time-series data sets for training TD using the feature amount.

In the class propagation step S105, the class propagation unit 12 associates at least a part of the class associated with another time-series data set for training TD with at least one time-series data set for training TD based on the similarity between the time-series data sets for training TD.

In the constraint condition applying step S106, the constraint condition assigning unit 18 assigns a constraint condition to limit the class of the pseudo label to the class of the label originally present in the time-series data set for training TD or the class of the label in the time-series data set for training TD obtained by being assigned by the class propagation unit.

In the pseudo label assigning step S107, for each time-series data set for training TD, the pseudo label assigning unit 13 assigns a pseudo label indicating a class into which the machine learning model MM has classified the data, to the data having no assigned label in the time-series data set for training TD. The pseudo label assigning step S107 limits the pseudo label to be assigned to the data included in the time-series data set for training TD based on the class associated with each time-series data set for training TD.

In the learning step S108, the learning unit 14 performs machine learning on the machine learning model MM by using a plurality of time-series data sets for training TD including data to which pseudo labels are given. For example, the learning unit S108 may further include a configuration that calculates a loss using a label originally assigned in the time-series data set for training TD, a pseudo label assigned in the time-series data set for training TD, and a result of inference as inputs, and updates a parameter of the machine learning model MM using the loss as an input.

### Effects of Present Example Embodiment

As described above, according to the learning device 10 and the learning method S10 according to the present example embodiment, it is possible to suppress assignment of a pseudo label of a wrong class such as a class not present in the time-series data set for training TD by assigning the constraint condition to the pseudo label. As a result, the number and variations of assigned pseudo labels increase, and it is expected that high inference accuracy can be obtained.

### Third Example Embodiment

A third exemplary example embodiment of the present invention will be described in detail with reference to the drawings. Components having the same functions as the components described in the first example embodiment are denoted by the same reference signs, and the description thereof will be appropriately omitted.

### Configuration of Learning Device 20

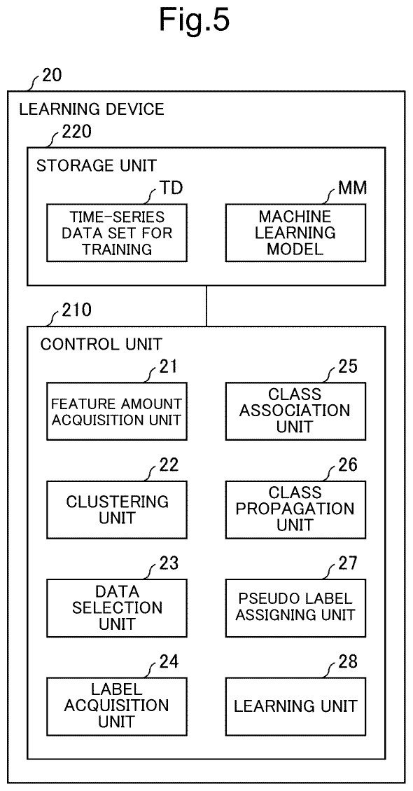

A configuration of a learning device 20 according to the third example embodiment of the present invention will be described with reference to FIG. 5. FIG. 5 is a block diagram illustrating a functional configuration of the learning device 20. As illustrated in FIG. 5, the learning device 20 includes a control unit 210 and a storage unit 220. The control unit 210 integrally controls each unit of the learning device 20. The control unit 210 includes a feature amount acquisition unit 21, a clustering unit 22, a data selection unit 23, a label acquisition unit 24, a class association unit 25, a class propagation unit 26, a pseudo label assigning unit 27, and a learning unit 28. The storage unit 220 stores various pieces of data used by the control unit 210. For example, the storage unit 220 stores a time-series data set for training TD and a machine learning model MM.

The feature amount acquisition unit 21 acquires a feature amount of the time-series data set for training TD.

The clustering unit 22 clusters the feature amounts obtained by the feature amount acquisition unit 21. For example, k-means and TWFINCH may be used as the clustering method.

The data selection unit 23 selects data from the vicinity of the center of each cluster using the result of clustering obtained by the clustering unit 22. In each cluster divided for each feature of the time-series data set for training TD, the data selection unit 23 selects data from the vicinity of the center of the cluster representing each feature and acquires the time of the selected data.

The label acquisition unit 24 acquires a label given to data at each time of the time-series data set for training TD relevant to the time obtained by the data selection unit 23. For example, the label acquired by the label acquisition unit 24 may be manually given to the data at each time of each time-series data set for training TD by a person, for example.

Since the class association unit 25, the class propagation unit 26, the pseudo label assigning unit 27, and the learning unit 28 have the same functions as the class association unit 11, the class propagation unit 12, the pseudo label assigning unit 13, and the learning unit 14 described in the first example embodiment, the description thereof will be omitted.

### Flow of Learning Method S20

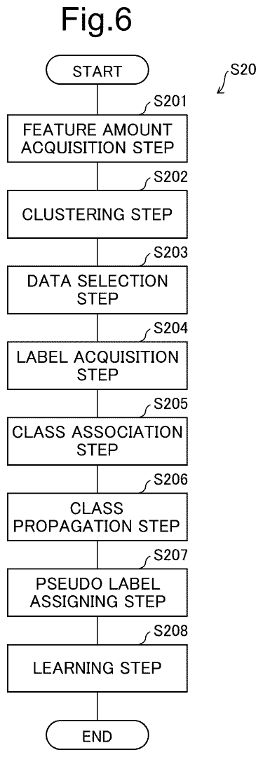

The learning device 20 configured as described above executes a learning method S20 according to the present example embodiment. A flow of the learning method S20 will be described with reference to FIG. 6. FIG. 6 is a flowchart illustrating the flow of the learning method S20. As illustrated in FIG. 6, the learning method S20 includes steps S201 to S208.

In the feature amount acquisition step S201, the feature amount acquisition unit 21 acquires a feature amount of the time-series data set for training TD.

In the clustering step S202, the clustering unit 22 clusters the feature amounts obtained in the feature amount acquisition step S201.

In the data selection step S203, the data selection unit 23 selects data from the vicinity of the center of each cluster using the result of clustering obtained by the clustering step S202.

In the label acquisition step S204, the label acquisition unit 24 acquires a label given to data at each time of the time-series data set for training TD relevant to the time obtained by the data selection step S203. The label acquired in the label acquisition step S204 is manually assigned to the data at each time of each time-series data set for training TD by a person, for example, and then the process proceeds to the processing in and after the class association step S205.

Since the class association step S205, the class propagation step S206, the pseudo label assigning step S207, and the learning step S208 have the same processes as the class association step S11, the class propagation step S12, the pseudo label assigning step S13, and the learning step S14 described in the first example embodiment, the description thereof is omitted.

### Effects of Present Example Embodiment

As described above, according to the learning device 20 and the learning method S20 according to the present example embodiment, it is possible to acquire data at each time of the time-series data set for training TD having different features in the time-series data set for training TD. By selecting in advance the data at each time of the time-series data set for training TD acquired in this manner as a target of labeling, it is possible to reduce the cost of searching for data to be labeled in the time-series data set for training TD.

### Example of Implementation by Software

Some or all of the functions of the learning devices 1, 10, and 20 (hereinafter, referred to as each device) may be achieved by hardware such as an integrated circuit (IC chip) or may be achieved by software.

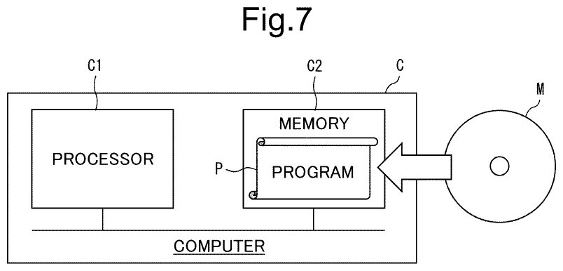

In the latter case, each device is achieved by, for example, a computer that executes an instruction of a program that is software for achieving each function. An example of such a computer (hereinafter, referred to as a computer C) is illustrated in FIG. 7. The computer C includes at least one processor C1 and at least one memory C2. A program P for operating the computer C as each device is recorded in the memory C2. In the computer C, the processor C1 reads the program P from the memory C2 and executes the program P to implement each function of each device.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Information 1

The present invention is not limited to the above-described example embodiments, and various modifications can be made within the scope described in the claims. For example, example embodiments obtained by appropriately combining the technical means disclosed in the above-described example embodiments are also included in the technical scope of the present invention.

### Supplementary Information 2

Some or all the above-described example embodiments may be described as the follows. However, the present invention is not limited to the following aspects.

### Supplementary Note 1

A learning device that performs machine learning of a machine learning model that infers into which class data at each time of a time-series data set is classified by using a plurality of time-series data sets for training, the learning device including:
a class association unit that associates a class indicated by a label attached to data included in each time-series data set for training with each time-series data set for training, the label indicating the class being given to some pieces of data included in the plurality of time-series data sets for training;
a class propagation unit that associates at least a part of a class associated with other time-series data sets for training with at least one time-series data set for training based on a similarity between the time-series data sets for training;
a pseudo label assigning unit that assigns, to each time-series data set for training, a pseudo label indicating a class into which the machine learning model has classified the data to data to which the label in the time-series data set for training is not assigned; and
a learning unit that performs machine learning of the machine learning model by using the plurality of time-series data sets for training including the data to which the pseudo label is given,
in which the pseudo label assigning unit limits the pseudo label assigned to data included in the time-series data set for training based on a class associated with each time-series data set for training.

### Supplementary Note 2

The learning device according to Supplementary Note 1, further including:
an inference unit that infers which class data at each time of the time-series data set for training is classified into;
a feature amount calculation unit that calculates a feature amount in units of time-series data sets for each of the time-series data sets for training;
a similarity calculation unit that calculates the similarity between the time-series data sets for training using the feature amount; and
a constraint condition assigning unit that assigns a constraint condition to limit the class of the pseudo label to the class of the label originally present in the time-series data set for training or the class of the label in the time-series data set for training obtained by being assigned by the class propagation unit,
in which the learning unit is configured to execute:
calculating a loss using the label originally assigned to the time-series data set for training, the pseudo label assigned to the time-series data set for training, and a result of the inference as inputs; and
updating a parameter of the machine learning model using the loss as an input.

### Supplementary Note 3

The learning device according to Supplementary Note 1 or 2, further including:
a feature amount acquisition unit that acquires a feature amount of the time-series data set for training;
a clustering unit that clusters the feature amounts obtained by the feature amount acquisition unit;
a data selection unit that selects data from near a center of each cluster using a result of the clustering obtained by the clustering unit; and
a label acquisition unit that acquires the label given to data at each time of the time-series data set for training relevant to a time obtained by the data selection unit.

### Supplementary Note 4

The learning device according to Supplementary Note 2 or 3, in which
the feature amount is an output result of a pre-learned model, a color feature, or meta information.

### Supplementary Note 5

The learning device according to Supplementary Note 4, in which
the meta information is an acquisition time of a time-series data set or an acquisition place of a time-series data set.

### Supplementary Note 6

A learning method for performing machine learning of a machine learning model that infers into which class data at each time of a time-series data set is classified by using a plurality of time-series data sets for training, the learning method including:
a class association process of associating a class indicated by a label attached to data included in each time-series data set for training with each time-series data set for training, the label indicating the class being given to some pieces of data included in the plurality of time-series data sets for training;
a class propagation process of associating at least a part of a class associated with other time-series data sets for training with at least one time-series data set for training based on a similarity between the time-series data sets for training;
a pseudo label assigning process of assigning, to each time-series data set for training, a pseudo label indicating a class into which the machine learning model has classified the data to data to which the label in the time-series data set for training is not assigned; and
a learning process of performing machine learning of the machine learning model by using the plurality of time-series data sets for training including the data to which the pseudo label is given,
in which the pseudo label assigning process limits the pseudo label assigned to data included in the time-series data set for training based on a class associated with each time-series data set for training.

### Supplementary Note 7

A learning program for causing a computer to execute machine learning of a machine learning model that infers into which class data at each time of a time-series data set is classified by using a plurality of time-series data sets for training, the program causing the computer to execute:
a class association process of associating a class indicated by a label attached to data included in each time-series data set for training with each time-series data set for training, the label indicating the class being given to some pieces of data included in the plurality of time-series data sets for training;
a class propagation process of associating at least a part of a class associated with other time-series data sets for training with at least one time-series data set for training based on a similarity between the time-series data sets for training;
a pseudo label assigning process of assigning, to each time-series data set for training, a pseudo label indicating a class into which the machine learning model has classified the data to data to which the label in the time-series data set for training is not assigned; and
a learning process of performing machine learning of the machine learning model by using the plurality of time-series data sets for training including the data to which the pseudo label is given,
in which the pseudo label assigning process limits the pseudo label assigned to data included in the time-series data set for training based on a class associated with each time-series data set for training.

### Supplementary Note 8

A learning device for performing machine learning of a machine learning model that infers into which class data at each time of a time-series data set is classified by using a plurality of time-series data sets for training, the learning device including at least one processor, in which
the processor is configured to execute:
a class association process of associating a class indicated by a label attached to data included in each time-series data set for training with each time-series data set for training, the label indicating the class being given to some pieces of data included in the plurality of time-series data sets for training;
a class propagation process of associating at least a part of a class associated with other time-series data sets for training with at least one time-series data set for training based on a similarity between the time-series data sets for training;
a pseudo label assigning process of assigning, to each time-series data set for training, a pseudo label indicating a class into which the machine learning model has classified the data to data to which the label in the time-series data set for training is not assigned; and
a learning process of performing machine learning of the machine learning model by using the plurality of time-series data sets for training including the data to which the pseudo label is given,
in which the pseudo label assigning process limits the pseudo label assigned to data included in the time-series data set for training based on a class associated with each time-series data set for training.

The learning device may further include a memory, and the memory may store a program for causing the processor to execute the class association process, the class propagation process, the pseudo label assigning process, and the learning process. This program may be recorded in a computer-readable non-transitory tangible recording medium.

### REFERENCE SIGNS LIST

1,10,20 learning device
11, 25 class association unit
12, 26 class propagation unit
13, 27 pseudo label assigning unit
14, 28 learning unit
15 inference unit
16 feature amount calculation unit
17 similarity calculation unit
18 constraint condition assigning unit
21 feature amount acquisition unit
22 clustering unit
23 data selection unit
24 label acquisition unit
110, 210 control unit
120, 220 storage unit
C1 processor
C2 memory

What is claimed is:

1. A learning device that performs machine learning of a machine learning model that infers into which class data at each time of a time-series data set is classified by using a plurality of time-series data sets for training, the learning device comprising:
one or more memories storing instructions; and
one or more processors configured to execute the instructions to:
associate a class indicated by a label attached to data included in each time-series data set for training with each time-series data set for training, the label indicating the class being given to some pieces of data included in the plurality of time-series data sets for training;
associate at least a part of a class associated with other time-series data sets for training with at least one time-series data set for training based on a similarity between the time-series data sets for training;
assign, to each time-series data set for training, a pseudo label indicating a class into which the machine learning model has classified the data for which the label in the time-series data set for training is not assigned;
perform machine learning of the machine learning model by using the plurality of time-series data sets for training including the data to which the pseudo label is given; and
limit the pseudo label assigned to data included in the time-series data set for training based on a class associated with each time-series data set for training.

2. The learning device according to claim 1,
wherein the one or more processors are further configured to execute the instructions to:
infer which class data at each time of the time-series data set for training is classified into;
calculate a feature amount in units of time-series data sets for each of the time-series data set for training;
calculate the similarity between the time-series data sets for training using the feature amount;
assign a constraint condition to limit the class of the pseudo label to the class of the label originally present in the time-series data set for training or the class of the label in the time-series data set for training obtained by being assigned;
calculate a loss using the label originally assigned to the time-series data set for training, the pseudo label assigned to the time-series data set for training, and a result of the inference as inputs; and
update a parameter of the machine learning model using the loss as an input.

3. The learning device according to claim 1,
wherein the one or more processors are further configured to execute the instructions to:
acquire a feature amount of the time-series data set for training;
cluster the feature amounts;
select data from near a center of each cluster using a result of the clustering; and
acquire the label given to data at each time of the time-series data set for training relevant to a time obtained from a process of selecting the data.

4. The learning device according to claim 2, wherein
the feature amount is an output result of a pre-learned model, a color feature, or meta information.

5. The learning device according to claim 4, wherein
the meta information is an acquisition time of a time-series data set or an acquisition place of a time-series data set.

6. A learning method for performing machine learning of a machine learning model that infers into which class data at each time of a time-series data set is classified by using a plurality of time-series data sets for training, the learning method comprising:
associating a class indicated by a label attached to data included in each time-series data set for training with each time-series data set for training, the label indicating the class being given to some pieces of data included in the plurality of time-series data sets for training;
associating at least a part of a class associated with other time-series data sets for training with at least one time-series data set for training based on a similarity between the time-series data sets for training;
assigning, to each time-series data set for training, a pseudo label indicating a class into which the machine learning model has classified the data for-to data to which the label in the time-series data set for training is not assigned;
performing machine learning of the machine learning model by using the plurality of time-series data sets for training including the data to which the pseudo label is given; and
limiting the pseudo label assigned to data included in the time-series data set for training based on a class associated with each time-series data set for training.

7. A non-transitory recording medium storing a learning program for causing a computer to execute machine learning of a machine learning model that infers into which class data at each time of a time-series data set is classified by using a plurality of time-series data sets for training, the recording medium causing the computer to execute:
associating a class indicated by a label attached to data included in each time-series data set for training with each time-series data set for training, the label indicating the class being given to some pieces of data included in the plurality of time-series data sets for training;
associating at least a part of a class associated with other time-series data sets for training with at least one time-series data set for training based on a similarity between the time-series data sets for training;
assigning, to each time-series data set for training, a pseudo label indicating a class into which the machine learning model has classified the data for which the label in the time-series data set for training is not assigned;
performing machine learning of the machine learning model by using the plurality of time-series data sets for training including the data to which the pseudo label is given; and
limiting the pseudo label assigned to data included in the time-series data set for training based on a class associated with each time-series data set for training.
